(19) United States
(12) Patent Application Publication
(10) Pub. No.: US 2026/0180686 A1
(43) Pub. Date: Jun. 25, 2026

(54) Communications Circuitry with Injection Locking Mode Control

(71) Applicant: Apple Inc., Cupertino, CA (US)

(72) Inventors: Nedim Muharemovic, Nuremberg (DE); Zdravko Boos, Munich (DE); Bertram R Gunzelmann, Königsbrunn (DE); Thomas Mayer, Linz (AT)

(21) Appl. No.: 18/990,412

(22) Filed: Dec. 20, 2024

(51) Int. Cl. H04B 10/50; H04B 10/2581

(52) U.S. Cl. CPC H04B 10/503; H04B 10/2581

(57) ABSTRACT

An electronic device may include signal generation circuitry that generates an optical signal for performing communications. The circuitry may include a laser coupled to a first port of an optical resonator over an optical path. An optical phase shifter may be disposed on the optical path. The signal generation circuitry may include multi-mode mitigation circuitry coupled in a loop between a second port of the optical resonator and the optical phase shifter. The laser may begin transmitting the optical signal. The laser may become injection locked to the optical resonator. The laser may initially operate in a multi-mode condition while injection locked to the optical resonator. The optical signal may include multiple signal peaks while the laser operates in the multi-mode condition. The multi-mode mitigation circuitry may process the optical signal until the optical signal includes only a single peak, corresponding to a single-mode condition of the laser.

### FIELD

This disclosure relates generally to electronic devices, including electronic devices with communications circuitry.

### BACKGROUND

Electronic devices can be provided with signal transmission capabilities. An electronic device with signal transmission capabilities has communications circuitry that conveys signals.

As software applications on electronic devices become more data-intensive over time, demand has grown for electronic devices that support communications at higher data rates. However, the maximum data rate supported by electronic devices is limited by the frequency of the transmitted signals. As communication frequencies increase, it can become more difficult to provide communications circuitry with sufficient levels of performance.

### SUMMARY

An electronic device may include communication circuity. The communication circuitry may include signal generation circuitry. The signal generation circuitry may generate an optical signal used in performing wired or wireless communications. The signal generation circuitry may include a laser coupled to a first port of an optical resonator over an optical path. An optical phase shifter may be disposed on the optical path. The signal generation circuitry may include multi-mode mitigation circuitry coupled in a loop between a second port of the optical resonator and the optical phase shifter. The optical resonator may have a third port that forms an output of the signal generation circuitry.

The laser may begin transmitting the optical signal. The laser may become injection locked to the optical resonator. The laser may initially operate in a multi-mode condition while injection locked to the optical resonator. The optical signal may include multiple signal peaks while the laser operates in the multi-mode condition. The multi-mode mitigation circuitry may process the optical signal until the optical signal includes only a single peak, corresponding to a single-mode condition of the laser. The multi-mode mitigation circuitry may include at least a photodiode, a mixer, and a comparator. The photodiode may generate an electrical signal based on the optical signal. The mixer may mix the electrical signal with itself to produce an error voltage. The comparator may generate a control signal by comparing the error voltage to a reference potential. The electrical signal may include radio-frequency beats when the laser is in the multi-mode condition. The radio-frequency beats may cause the mixer to generate the error voltage with a non-zero magnitude. The control signal may adjust the optical phase shifter until the optical signal includes only a single peak, which may cause the error voltage to fall to zero.

An aspect of the disclosure provides communication circuitry. The communication circuitry can include a laser. The communication circuitry can include an optical resonator having a first port and a second port. The communication circuitry can include a first optical path that couples the laser to the first port of the optical resonator. The communication circuitry can include an optical phase shifter on the first optical path. The communication circuitry can include a photodiode. The communication circuitry can include a second optical path that couples the second port of the optical resonator to the photodiode. The communication circuitry can include a comparator. The communication circuitry can include a mixer coupled between the photodiode and an input of the comparator. The communication circuitry can include a control path that couples an output of the comparator to the optical phase shifter.

An aspect of the disclosure provides a method of generating an optical signal usable for performing communications. The method can include generating, using a laser coupled to a first port of an optical resonator, the optical signal as a multi-mode signal while the laser is injection-locked to the optical resonator. The method can include converting, using circuitry coupled in a loop between a second port of the optical resonator and an optical phase shifter, the optical signal into a single-mode signal while the laser is injection-locked to the optical resonator, wherein the optical phase shifter is coupled between the laser and the first port of the optical resonator.

An aspect of the disclosure provides communication circuitry. The communication circuitry can include a first optical resonator. The communication circuitry can include a first laser coupled to a first port of the first optical resonator and configured to generate a first optical signal at a first frequency while injection-locked to the first optical resonator. The communication circuitry can include an optical phase shifter coupled between the first laser and the first port. The communication circuitry can include multi-mode mitigation circuitry coupled in a loop between a second port of the optical resonator and the optical phase shifter, wherein the multi-mode mitigation circuitry is configured to adjust the optical phase shifter while the first laser emits the first optical signal in a multi-mode condition until the first laser emits the first optical signal in a single-mode condition.

### BRIEF DESCRIPTION OF THE DRAWINGS

FIG. 1 is a block diagram of an illustrative electronic device having communications circuitry in accordance with some embodiments.

FIG. 2 is a diagram of an illustrative optical resonator that may be included in signal generation circuitry in accordance with some embodiments.

FIG. 3 is a circuit diagram of illustrative signal generation circuitry that includes a light source and multi-mode mitigation circuitry in accordance with some embodiments.

FIG. 4 is a flow chart of illustrative operations involved in transmitting signals in accordance with some embodiments.

FIG. 5 is a circuit diagram of illustrative wireless circuitry that includes multiple laser modules for generating optical signals used to convey radio-frequency signals in accordance with some embodiments.

### DETAILED DESCRIPTION

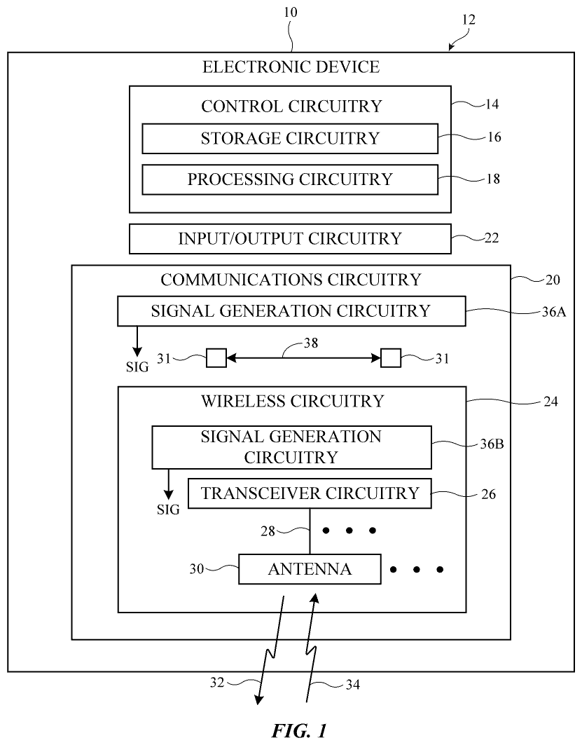

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head (e.g., a virtual, augmented, mixed, or extended reality headset or head-mounted display device), or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, an integrated circuit package, a computer motherboard, a graphics processing chip, a server, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol. Control circuitry 14 may also be used in implementing wired communications protocols.

Device 10 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Device 10 may also include communications circuitry 20 for transmitting, conveying, and/or receiving signals between device 10 and external equipment such as one or more external devices (e.g., other devices such as device 10 or other types of communications equipment) and/or between components within device 10. Communications circuitry 20 is sometimes also referred to herein as communication circuitry. If desired, communications circuitry 20 may include wireless circuitry 24 to support wireless communications. Wireless circuitry 24 (sometimes referred to herein as wireless communications circuitry 24) may include one or more antennas 30 (e.g., antenna elements).

Wireless circuitry 24 may also include transceiver circuitry 26. Transceiver circuitry 26 may include transmitter circuitry, receiver circuitry, modulator circuitry, photomixers, demodulator circuitry (e.g., one or more modems), radio-frequency circuitry, one or more radios, intermediate frequency circuitry, optical transmitter circuitry, optical receiver circuitry, optical light sources, other optical components, baseband circuitry (e.g., one or more baseband processors), amplifier circuitry, clocking circuitry such as one or more local oscillators and/or phase-locked loops, memory, one or more registers, filter circuitry, switching circuitry, analog-to-digital converter (ADC) circuitry, digital-to-analog converter (DAC) circuitry, radio-frequency transmission lines, optical fibers, and/or any other circuitry for transmitting and/or receiving wireless signals using antennas 30. The components of transceiver circuitry 26 may be implemented on one integrated circuit, chip, system-on-chip (SOC), die, printed circuit board, substrate, or package, or the components of transceiver circuitry 26 may be distributed across two or more integrated circuits, chips, SOCs, printed circuit boards, substrates, and/or packages.

The example of FIG. 1 is illustrative and non-limiting. Although control circuitry 14 is shown separately from communications circuitry 20 in the example of FIG. 1 for the sake of clarity, communications circuitry 20 and/or wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of wireless circuitry 24 and/or communications circuitry 20. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

Transceiver circuitry 26 may be coupled to each antenna 30 in wireless circuitry 24 over a respective signal path 28. Each signal path 28 may include one or more radio-frequency transmission lines, waveguides, optical paths, optical fibers, optical waveguides, and/or any other desired lines/paths for conveying wireless signals between transceiver circuitry 26 and antenna 30. Antennas 30 may be formed using any desired antenna structures for conveying wireless signals. For example, antennas 30 (e.g., antenna elements) may include resonating elements (radiators) that are formed from dipole antenna structures, planar dipole antenna structures (e.g., bowtie antenna structures), slot antenna structures, loop antenna structures, patch antenna structures, inverted-F antenna structures, planar inverted-F antenna structures, helical antenna structures, monopole antennas, dipoles, hybrids of these designs, or any other antenna types. Filter circuitry, switching circuitry, impedance matching circuitry, and/or other antenna tuning components may be adjusted to adjust the frequency response and wireless performance of antennas 30 over time.

If desired, two or more of antennas 30 may be integrated into a phased antenna array (sometimes referred to herein as a phased array antenna) in which each of the antennas conveys wireless signals with a respective phase and magnitude that is adjusted over time so the wireless signals constructively and destructively interfere to produce (form) a signal beam in a given pointing direction. The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of currents on an antenna resonating (radiating) element in the antenna by signals within the frequency band(s) of operation of the antenna.

Transceiver circuitry 26 may use antenna(s) 30 to transmit and/or receive wireless signals that convey wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data symbols, packets, datagrams, and/or frames such as wireless data associated with a telephone call, streaming media content, internet browsing, wireless data associated with software applications running on device 10, email messages, etc.

Additionally or alternatively, wireless circuitry 24 may use antenna(s) 30 to perform wireless sensing operations. The sensing operations may allow device 10 to detect (e.g., sense or identify) the presence, location, orientation, and/or velocity (motion) of objects external to device 10 (e.g., using a radar scheme or another spatial ranging scheme). Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc.

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1(FR1) bands below 10 GHz, 5G New Radio Frequency Range 2(FR2) bands between 20 and 60 GHz, etc.), other centimeter or millimeter wave frequency bands (e.g., between 10-300 GHz), near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Communications circuitry on the electronic devices therefore needs to support data transfer at higher and higher data rates. In general, the data rates supported by the communications circuitry are proportional to the frequency of the signals conveyed by the communications circuitry (e.g., higher frequencies can support higher data rates than lower frequencies). Communications circuitry 20 may convey centimeter and millimeter wave signals to support relatively high data rates (e.g., because centimeter and millimeter wave signals are at relatively high frequencies between around 10 GHz and 300 GHz). However, the data rates supported by centimeter and millimeter wave signals may still be insufficient to meet all the data transfer needs of device 10. To support even higher data rates such as data rates up to 5-10 Gbps or higher, communications circuitry 20 may convey wireless signals at frequencies greater than around 100 GHz.

As shown in FIG. 1, wireless circuitry 24 may transmit wireless signals 32 and may receive wireless signals 34. Wireless signals 32 and 34 may be conveyed at frequencies greater than around 100 GHz if desired (sometimes also referred to as tremendously high frequency (THF) frequencies). When conveyed at frequencies greater than about 100 GHz, wireless signals 32 and 34 are sometimes also referred to herein as THF signals, sub-THz signals, THz signals, or sub-millimeter wave signals. THF signals conveyed by wireless circuitry 24 may be at sub-THz or THz frequencies such as frequencies between about 100 GHz and about 1 THz, between about 100 GHz and about 10 THz, between 100 GHz and 2 THz, between 200 GHz and 1 THz, between 300 GHz and 1 THz, between 300 GHz and 2 THz, between 300 GHz and 10 THz, between 100 GHz and 800 GHz, between 200 GHz and 1.5 THz, etc. (e.g., within a sub-THz, THz, THF, or sub-millimeter frequency band such as a 3GPP Sixth Generation (6G) frequency band).

The high data rates supported by these frequencies may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits wireless signals 32 to another antenna 30 on a second chip in device 10), and/or to perform any other desired high data rate operations. Wireless circuitry 24 may include one or more antennas 30 that convey THF signals (e.g., at frequencies greater than around 100 GHz) and/or may include one or more antennas 30 that convey non-THF signals (e.g., at frequencies less than around 100 GHz). These examples are illustrative and, if desired, wireless circuitry 24 may convey wireless signals 32 and 34 in other frequency bands.

Communications circuitry 20 may include signal generation circuitry 36. Signal generation circuitry 36 may generate and output a signal (SIG) at relatively high frequencies. Signal SIG may be, for example, a radio-frequency signal at frequencies between around 600 MHz and around 10 THz or may be an optical signal at optical frequencies (e.g., visible frequencies, infrared or near infrared frequencies, ultraviolet frequencies, etc.). Communications circuitry 20 may use signal SIG to convey wireless data (or other signals that do not carry wireless data) with an external device. The high frequency of signal SIG may serve to maximize the data rate with which communications circuitry 20 conveys wireless data with the external device.

Signal generation circuitry 36 may, for example, include digital, analog, and/or optical clocking circuitry that generates signal SIG. Communications circuitry 20 may use signal SIG to clock signal transmission and/or reception by device 10 (e.g., signal SIG may be a clocking signal such as an electrical or optical local oscillator signal). The clocking circuitry may include one or more oscillators (e.g., reference oscillators, crystal oscillators, voltage controlled oscillators, etc.), phase locked loops (PLLs), frequency locked loops (FLLs), self-injection-locking loops, and/or other clocking circuitry that generates signal SIG. Signal generation circuitry 36 is sometimes also referred to herein as clocking circuitry 36 or signal generator 36.

If desired, communications circuitry 20 may use signal SIG to upconvert and/or downconvert an additional signal between different frequencies (e.g., by providing signal SIG and the additional signal to mixer circuitry that upconverts or downconverts the additional signal to a desired frequency by mixing the additional signal with signal SIG). The additional signal may carry data (e.g., a stream of data bits organized into a corresponding data structure such as a packet, frame, symbol, datagram, etc.).

As another example, communications circuitry 20 may modulate data onto signal SIG itself and the modulated signal may be transmitted to an external device and/or may be used to generate other signals that are transmitted to an external device. As another example, communications circuitry 20 may receive a signal that carries modulated data and may use signal SIG to convert, demodulate, mix, and/or otherwise process the received signal carrying the modulated data. In general, signal SIG may be any desired signal that is transmitted by communications circuitry 20 to an external device, that is used by communications circuitry 20 to transmit other signals to an external device, that is used by communications circuitry 20 to receive other signals from an external device, that is transmitted between components 31 in device 10, that is used to transmit another signal between components 31 in device 10, or that is used to receive another signal between components 31 in device 10. One or more of components 31 may be formed within wireless circuitry 24, within transceiver circuitry 26, within input/output devices 22, or within control circuitry 14 if desired.

Signal generation circuitry 36 may include electro-optical (EO) signal generation circuitry or may include electrical signal generation circuitry. EO signal generation circuitry (e.g., EO clocking circuitry) in signal generation circuitry 36 may generate signal SIG in the optical domain (e.g., signal SIG may be an optical signal such as an optical local oscillator signal) or in the electrical domain (e.g., signal SIG may be an electrical signal such as a radio-frequency signal). The EO signal generation circuitry may include one or more electro-optical phase locked loops (EOPLLs), EO FLLs, and/or EO self-injection-locking loops if desired. Electrical signal generation circuitry in signal generation circuitry 36 may generate signal SIG in the electrical domain (e.g., at radio frequencies).

If desired, signal generation circuitry 36 may include signal generation circuitry 36B in wireless circuitry 24. Wireless circuitry 24 may use signal generation circuitry 36B to transmit wireless signals 32 and/or to receive wireless signals 34 using transceiver circuitry 26 and antenna(s) 30. Signal generation circuitry 36B may be included within transceiver circuitry 26 or may be external to transceiver circuitry 36B. Signal generation circuitry 36B may provide signal SIG to one or more mixers, photomixers (e.g., photodiodes), and/or other circuitry in transceiver circuitry 26, for example.

If desired, signal generation circuitry 36 may include signal generation circuitry 36A in communications circuitry 20 but external to wireless circuitry 24. Communications circuitry 20 may use signal generation circuitry 36A to convey electrical or optical signals over a signal path 38 between components 31 in communications circuitry 20. Signal path 38 may be a wired signal path (e.g., a radio-frequency transmission line path that conveys electrical signals or an optical path that conveys optical signals). Components 31 may be any desired components in communications circuitry 20 and/or device 10.

As one example, a first component 31 may generate a signal that includes or that is based on (e.g., clocked using) the signal SIG generated by signal generation circuitry 36A and may transmit the generated signal to a second component 31 over signal path 38. The second component 31 may be, for example, an electrical connector (e.g., a radio-frequency connector) that is coupled to an external device over an external electrical signal path (e.g., a cable or radio-frequency transmission line). The electrical connector may transmit the signal from signal path 38 to the external device over the external signal path. Alternatively, the second component 31 may be an optical connector that is coupled to the external device over an external optical signal path (e.g., an optical fiber or waveguide). The optical connector may transmit the signal from signal path 38 to the external device over the external signal path.

Conversely, the second component 31 may be an electrical connector that receives an electrical signal from the external device over an external electrical signal path or may be an optical connector that receives an optical signal from the external device over an external optical signal path. The second component 31 may transmit the electrical or optical signal to the first component 31 over signal path 38. The first component 31 may receive and process (e.g., downconvert, upconvert, mix, etc.) the electrical or optical signal using the signal SIG generated by signal generation circuitry 36A. If desired, wireless circuitry 24 may be omitted from device 10 (e.g., device 10 need not convey wireless signals).

If desired, one or more mixers in communications circuitry 20 may receive signal SIG for converting other signals between different frequencies (e.g., between baseband frequencies, intermediate frequencies, radio frequencies, optical frequencies, etc.). The mixers may include one or more radio mixers (e.g., for converting between radio, intermediate, and/or baseband frequencies) and/or one or more electro-optical (EO) mixers (e.g., for converting between radio frequencies and optical frequencies or between optical frequencies). The EO mixers are sometimes referred to herein as photomixers and may include photodiodes (e.g., uni-travelling-carrier photodiodes (UTC PDs) or other types of programmable photodiodes), electrooptical modulators (e.g., Mach-Zehnder modulators), and/or other mixers that convert signals from radio frequencies to optical frequencies and/or from optical frequencies to radio frequencies.

When signal SIG is used to convey wired and/or wireless signals at relatively high frequencies (e.g., radio frequencies greater than around 10-100 GHz, optical frequencies, etc.), if care is not taken, signal SIG can exhibit excessive phase noise and/or jitter. Excessive phase noise and jitter can undesirably deteriorate the wired and/or wireless signals conveyed between device 10 and the external device. Phase noise and jitter is also particularly sensitive to temperature. Variations in temperature can produce different amounts of phase noise and jitter. Additional devices such as thermo-electrical coolers (e.g., Peltier elements) can be used to help control the temperature of communications circuitry 20 and thus phase noise and jitter, but can be excessively bulky, expensive, and power hungry.

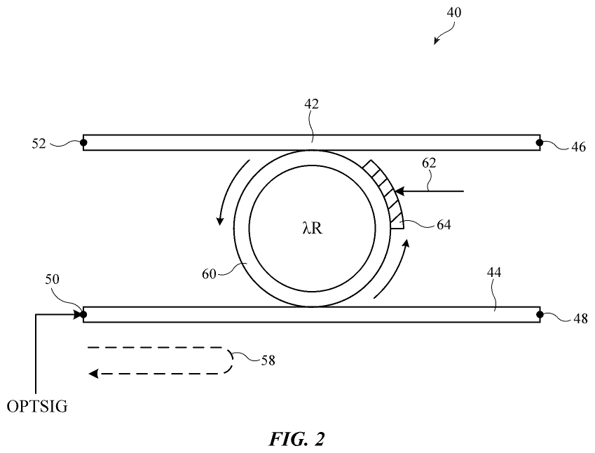

To help mitigate these issues, signal generation circuitry 36 may include a self-injection locking loop with a light source and a resonator that is used to mitigate phase noise and jitter across operating temperatures (e.g., without requiring additional bulky temperature control devices such as thermo-electrical coolers). In implementations that are described herein as an example, the light source may include a laser and the resonator may include an optical resonator. The optical resonator may be used to perform self-injection locking of the laser. FIG. 2 is a diagram of an illustrative optical resonator 40 that may be optically coupled to a laser in signal generation circuitry 36. Optical resonator 40 may be, for example, an optical micro-resonator (MR) that contains a resonant optical loop such as optical loop 60 (e.g., a loop or ring of optical fiber or waveguide).

As shown in FIG. 2, optical resonator 40 may also include a first optical path 44 (e.g., a first optical fiber or waveguide) and a second optical path 42 (e.g., a second optical fiber or waveguide). Optical loop 60 may be physically and optically interposed between optical paths 44 and 42. Optical loop 60 may optically couple optical path 44 to optical path 42 (e.g., optical loop 60 may be optically coupled between optical paths 42 and 44).

Optical resonator 40 may have a first port 50 coupled to a first end of optical path 44, a second port 48 coupled to a second end of optical path 44, a third port 52 couple to a first end of optical path 42, and a fourth port 46 coupled to a second end of optical path 42. Optical resonator 40 may receive optical signals at port 50 and/or port 52 and may output optical signals at port 48 and/or port 46. Port 46 is sometimes also referred to as the drop port 46 of optical resonator 40. Port 52 is sometimes also referred to as the add port 52 of optical resonator 40. Port 50 is sometimes also referred to as the input port of optical resonator 40. Port 48 is sometimes also referred to as the through port of optical resonator 40.

During operation, optical loop 60 may carry an optical signal in a set of optical resonances each at a corresponding optical resonant wavelength. The set of optical resonances is sometimes also referred to as an optical comb, a wavelength comb, or a frequency comb. The dimensions of optical loop 60 (e.g., the radius or diameter of optical loop 60) may establish the particular optical resonances (resonant wavelengths) of the optical comb for the optical resonator.

An optical signal OPTSIG may be incident upon input port 50 of optical resonator 40 from a light source (e.g., a laser). The wavelength of optical signal OPTSIG matching one or more resonant wavelengths λR of optical loop 60 may be coupled off of optical path 44 and onto optical loop 60, may resonate around optical loop 60, and may be coupled off of optical loop 60 and onto optical path 42, which propagates the wavelength(s) λR of optical signal OPTSIG to port 46. Optical resonator 40 may output the resonant wavelength(s) λR of optical signal OPTSIG at port 46 and/or at port 48. In this way, optical resonator 40 may also serve as an optical filter for optical signal OPTSIG.

At the same time, at least some of the optical signal OPTSIG received at input port 50 may be reflected by optical loop 60 back towards input port 50, as shown by arrow 58. For example, the at least some of the wavelength(s) of optical signal OPTSIG matching the wavelengths of the optical resonance(s) of optical loop 60 may be reflected back towards input port 60 as a reflected optical signal. Optical resonator 40 may output this reflected optical signal at input port 50. If desired, the reflected optical signal may be injected into the laser that emitted optical signal OPTSIG (e.g., injection locking the laser to an optical resonance of the optical resonator). The laser may, for example, be locked to a resonant wavelength λR of optical resonator 40.

If desired, optical resonator 40 may include a mechanical actuator such as actuator 64. Actuator 98 may receive an electrical signal such as control signal 62 (e.g., a voltage or current signal). Control signal 62 may cause actuator 98 to mechanically adjust the physical dimensions of optical loop 60 (e.g., diameter, radius, width, length, etc.). This adjustment may change the resonant wavelengths of the optical resonances in the optical comb of optical loop 60. Actuator 64 may include an electromechanical actuator such as a piezoelectric actuator, a microelectromechanical systems (MEMS) actuator, thermal circuitry, a PN junction, or another type of actuator.

In practice, the laser that outputs optical signal OPTSIG outputs the optical signal with a gain curve that extends across a range of optical frequencies or wavelengths. Optical resonator 40 may exhibit a set of multiple resonances (e.g., a portion of a resonant comb at wavelength(s) λR) overlapping the gain curve. After self-injection locking the laser to the optical resonator, the optical signal may exhibit multiple oscillations/peaks at the frequencies of the set of resonances. Under this condition, the laser is sometimes referred to as being in a multi-mode operation state or mode.

However, it may be desirable for the optical signal to exhibit only a single oscillation, mode, or peak at one of the frequencies of the set of resonances when used to perform signal transmission (e.g., as signal SIG). In some implementations, an optical/thermal phase shifter may be coupled between the laser and the optical resonator and may detune the phase of the optical signal after self-injection locking so that only a single one of the oscillations/peaks dominates the optical signal. However, this technique may require active measurement of the entire spectrum of the optical signal to ensure that the correct phase is implemented by the phase shifter. Measuring the entire spectrum of the optical signal may require bulky, power-hungry, and/or costly measurement equipment and may consume an excessive amount of time.

In other implementations, multiple different optical resonators 40 having different geometries/resonances may be optically coupled together and to the output of the laser for self-injection locking the laser (e.g., based on the Vernier effect). The different geometries of the multiple optical resonators configure each optical resonator to exhibit a different respective comb of resonant frequencies with different respective comb spacings. Each optical resonator may filter the optical signal such that, after self-injection locking, the optical signal exhibits signal peaks/resonances only at frequencies under its gain curve where the resonant frequencies of each of the differently-spaced combs of resonant frequencies of the optical resonators overlap. When only one such overlapping frequency exists under the gain curve of the optical signal, a filtered optical signal at only a single frequency may be produced. Under this condition, the laser is sometimes referred to as being in a single-mode operation state or mode. When operating as a single-mode laser, the optical signal output by the laser may be used for more stable and reliable signal transmission than when operating as a multi-mode laser. However, optical resonators are relatively large and utilizing multiple optical resonators to self-injection lock a laser can consume an excessive amount of area in devices where space is at a premium, such as in device 10. It would therefore be desirable to self-injection lock the laser using only a single optical resonator, while also configuring the laser to operate as a single-mode laser for performing satisfactory communications.

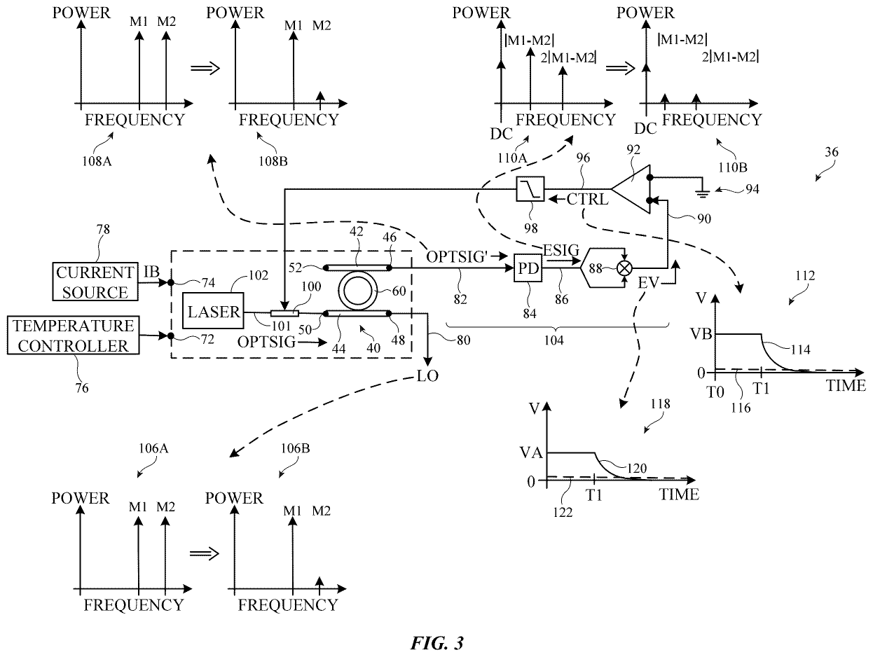

FIG. 3 is a circuit diagram showing one example of signal generation circuitry 36 that includes a laser that is self-injection locked using a single optical resonator 40 and that includes multi-mode mitigation circuitry that configures the laser to operate as a single-mode laser. In the example of FIG. 3, signal generation circuitry 36 generates an optical local oscillator signal LO (e.g., as signal SIG of FIG. 1) for use in performing communications.

As shown in FIG. 3, signal generation circuitry 36 may include a light source such as laser 102, a corresponding optical resonator 40, and multi-mode mitigation circuitry 104. The output of laser 102 may be optically coupled to the input port 50 of optical resonator 40 over optical path 101. Port 48 of optical resonator 40 may be coupled to an optical output path of signal generation circuitry 36 such as optical path 80 (e.g., optical path 80 may form the signal output of signal generation circuitry 36 and is sometimes also referred to herein as optical output 80 or optical output path 80). Multi-mode mitigation circuitry 104 may be coupled between port 46 of optical resonator 40 and optical path 101 (e.g., may form a loop path between optical resonator 40 and optical path 101).

If desired, laser 102, optical resonator 40, and/or optical path 101 may be integrated into and/or onto a corresponding optical (laser) module 70 (e.g., disposed on a shared substrate such as a printed circuit board substrate, a package substrate, a semiconductor substrate, an integrated circuit chip, a photonic integrated circuit, etc.). Multi-mode mitigation circuitry 104 may be disposed on and/or in optical module 70 or may be separate from optical module 70. If desired, signal generation circuitry 36 may include a temperature controller 76 coupled to a temperature control input 72 of optical module 70. Temperature controller 76 may, for example, provide a control signal to temperature control input 72 that serve to set, control, and/or adjust the temperature of optical module 70 and the components disposed on optical module 70. Temperature controller 76 may be omitted if desired.

Signal generation circuitry 36 may also include a current source 78 that is coupled to a bias input 74 of optical module 70 (e.g., a current bias terminal of laser 102). Current source 78 may output a bias current IB and may provide bias current IB to bias input 74 to control (bias) laser 102. Bias current IB may, for example, control laser 102 to emit optical signal OPTSIG onto optical path 101. Additionally, or alternatively, laser 102 may be controlled by a corresponding bias voltage (e.g., bias current IB may be replaced by a bias voltage that controls laser 102 to output optical signal OPTSIG). Current source 78 and/or temperature controller 76 may be integrated into optical module 70 or may be separate from optical module 70.

Optical module 70 may also include an optical phase shifter such as optical phase shifter 100 disposed on optical path 101. Optical phase shifter 100 may receive an electrical control signal that controls the optical phase shifter to apply a corresponding optical phase shift to the optical signal OPSIG propagating along optical path 101. Optical phase shifter 100 may be, as one non-limiting example, a thermal phase shifter that performs optical phase shifting by thermally adjusting one or more path lengths followed by optical signal OPTSIG along optical path 101. Optical phase shifter 100 may, for example, receive an electrical control signal CTRL form multi-mode mitigation circuitry 104 (e.g., multi-mode mitigation circuitry 104 may be coupled between port 46 of optical resonator 40 and an electrical control input of optical phase shifter 100 in a loop path between optical resonator 40 and optical phase shifter 100).

Multi-mode mitigation circuitry 104 may include a photomixer or electro-optical heterodyning device (e.g., a square law device) such as photodiode (PD) 84. Multi-mode mitigation circuitry 104 may also include electrical mixing circuitry such as mixer 88 (e.g., an analog and/or digital multiplier, multiplication, or mixing circuit), comparator circuitry such as comparator 92, and filter circuitry such as filter 98. Port 46 of optical resonator 40 may be optically coupled to a photo-active portion of photodiode 84 by optical path 82. Photodiode 84 may have an electrical output or terminal coupled to an electrical signal path such as signal path 86. Signal path 86 may be coupled to first and second inputs of mixer 88 in parallel.

Comparator 92 may include first and second inputs. The first input of comparator 92 may be coupled to the output of mixer 88 over an electrical signal path such as signal path 90. The second input of comparator 92 may be coupled to a reference potential such as reference potential 94 (e.g., a ground voltage or another reference voltage). The output of comparator 92 may be coupled to the electrical control input of optical phase shifter 100 over electrical control path 96. Filter 98 may be disposed on control path 96 and may be operably coupled in series between the output of comparator 92 and optical phase shifter 40. Filter 98 may include, for example, an electrical low pass filter. In this way, multi-mode mitigation circuitry 104 may form a loop path extending from optical resonator 40, through optical path 82, photodiode 84, electrical path 86, mixer 88, signal path 90, comparator 92, and control path 96. Optical paths 101, 80, and 82 may include any desired number of optical fibers and/or waveguides. Additional optical and/or electrical components may be included in optical module 70 and/or multi-mode mitigation circuitry 104 (e.g., lenses, filters, switches, signal couplers, optical combiners, optical splitters, signal splitters, signal combiners, etc.) if desired, but have been omitted from FIG. 3 for the sake of simplicity.

Signal generation circuitry 36 may begin to generate optical local oscillator signal LO by turning laser 102 on (e.g., using current source 78), causing the laser to begin emitting optical signal OPTSIG on optical path 101. Optical path 101 may propagate optical signal OPTSIG to optical resonator 40. Optical signal OPTSIG may resonate in the optical ring 60 of optical resonator 40, and some of optical signal OPTSIG may be reflected by optical resonator 40 back towards laser 102. This reflected optical signal may be injected into laser 102 (e.g., via its output) and may serve to self-injection lock laser 102 to the resonance of optical resonator 40.

After laser 102 has injection locked to optical resonator 40, a portion of optical signal OPTSIG may pass from optical resonator 40 onto optical path 82 via port 46 as optical signal OPTSIG′ (e.g., a filtered version of optical signal OPTSIG). A portion of optical signal OPTSIG may also pass from optical resonator 40 onto optical path 80 as optical local oscillator signal LO. Prior to multi-mode mitigation by multi-mode mitigation circuitry 104, laser 102 may be in a multi-mode condition, mode, or state (e.g., may operate as a multi-mode laser) and the optical signal may contain multiple signal peaks at different frequencies.

Plots 108 of FIG. 3 illustrate the signal level (e.g., power) of the optical signal OPTSIG′ on optical path 82 as a function of frequency at different times. Plot 108A illustrates optical signal OPTSIG′ while laser 102 is in the multi-mode condition (e.g., at a first time prior to completion of multi-mode mitigation). Plots 106 illustrate the signal level of the optical local oscillator signal LO on optical path 80 as a function of frequency at different times. Plot 106A illustrates optical local oscillator signal LO while laser 102 is in the multi-mode condition (e.g., at the first time).

As shown by plots 108A and 106A, at the first time, optical signal OPTSIG and optical signal OPTSIG′ may each include multiple resonant peaks (e.g., maxima in signal power as a function of frequency) at corresponding resonant frequencies M. In a simplest case, illustrated in FIG. 3 for the sake of simplicity, optical signal OPTSIG and optical signal OPTSIG′ may each include at least a first resonant peak at frequency M1 (e.g., associated with a first mode of laser 102 in the multi-mode condition) and a second resonant peak at frequency M2 (e.g., associated with a second mode of laser 102 in the multi-mode condition) at the first time. As described below, multi-mode mitigation circuitry 104 may perform multi-mode mitigation (e.g., in one or more iterations or loops through multi-mode mitigation circuitry 104) to effectively remove all but one of the resonant peaks of optical signals OPTSIG and OPTSIG′, which may effectively place the laser in a single-mode condition, mode, or state.

Optical path 82 may illuminate the photosensitive (photoactive) area of photodiode 84 using optical signal OPTSIG′. Photodiode 84 may generate an electrical signal ESIG on signal path 86 based on optical signal OPTSIG′. Photodiode 84 may, for example, perform a square law or heterodyning operation on signal components at different frequencies (modes) in optical signal OPTSIG′, which generates electrical signal ESIG as an electrical beat signal between the different frequencies/modes of the optical signal (e.g., at a beat frequency given by differences between the wavelengths/frequencies of the different modes in optical signal OPTSIG′).

Plots 110 illustrate the signal level of the electrical signal ESIG on signal path 80 as a function of frequency at different times. Plot 110A illustrates electrical signal ESIG while laser 102 is in the multi-mode condition (e.g., at the first time). As shown by plot 110A, at the first time, the heterodyning performed by photodiode 84 may produce three signal peaks in electrical signal ESIG from the two signal peaks (modes) at frequencies M1 and M2 in optical signal OPTSIG′. The signal peaks in electrical signal ESIG may include, for example, a first signal peak at a direct current (DC) frequency, a second signal peak at a beat frequency |M1−M2|, given by the absolute value of the difference between frequencies M1 and M2, and a third peak at a frequency 2*|M1−M2|.

Signal path 86 may concurrently transmit electrical signal ESIG to both the first and second inputs of mixer 88. Mixer 88 may self-mix electrical signal ESIG with itself (e.g., by multiplying or mixing electrical signal ESIG, as received at the first input of mixer 88, with the same signal as received at the second input of mixer 88). The self-mixing performed by mixer 88 may produce a corresponding error voltage EV on signal path 90. Signal path 90 may transmit error voltage EV to the first input of comparator 92.

Curve 120 in plot 118 of FIG. 3 illustrates the magnitude of error voltage EV (e.g., in volts (V)) as a function of time. As shown by curve 120, error voltage EV has a magnitude VA that is greater than zero at the first time (e.g., a time between times T0 and T1). This is due to mixing of the first signal peak in electrical signal ESIG (e.g., at frequency |M1−M2|) with the second signal peak in electrical signal ESIG (e.g., at frequency 2*|M1−M2|) by mixer 88, which causes the error voltage EV to exhibit a magnitude greater than zero such as magnitude VA. Put differently, the presence of beating in electrical signal ESIG (e.g., as produced from the heterodyning of multiple signal peaks in optical signal OPTSIG′ by photodiode 84 while laser 102 is in a multi-mode condition) causes error voltage EV to exhibit magnitude VA. If desired, a voltage detector may be coupled to signal path 90 to detect whether laser 102 is operating in a multi-mode condition based on a detection of error voltage EV (e.g., the voltage detector may determine that laser 102 is in the multi-mode condition if/when error voltage EV exceeds a threshold, is greater than zero, and/or has magnitude VA).

For example, comparator 92, control path 96, and filter 98 may effectively form a voltage detector for error voltage EV and may use the detection of error voltage EV to actively adjust optical phase shifter 100 until laser 102 begins operating in a single-mode condition instead of the multi-mode condition. For example, comparator 92 may compare error voltage EV to reference potential 94 and may output control signal CTRL on control path 96 based on the comparison. Curve 114 in plot 112 of FIG. 3 illustrates the magnitude of the control signal CTRL generated by comparator 92 based on error voltage EV and reference potential 94. As shown by curve 114, control signal CTRL may have a voltage magnitude VB while error voltage EV exceeds reference potential 94 and may have a magnitude of zero while error voltage EV is less than reference potential 94. The relatively high magnitude VA of error voltage EV while laser 102 is operating in the multi-mode condition may cause control signal CTRL to exhibit magnitude VB at the first time (e.g., a time between times T0 and T1).

If desired, low pass filter 98 may filter out high frequency components of control signal CTRL (e.g., passing only the DC component of control signal CTRL). Control path 96 may provide control signal CTRL to optical phase shifter 100. Optical phase shifter 100 may adjust the phase of the optical signal OPTSIG output by laser 102 (e.g., may apply a dynamic optical phase shift to optical signal OPTSIG) based on control signal CTRL (e.g., based on the error voltage EV produced by mixer 88). This process may iterate one or more times in the loop around optical resonator 40 (e.g., through multi-mode mitigation circuitry 104), which reduces error voltage EV (e.g., beginning at time T1 as shown by curve 120) and thus the magnitude of control signal CTRL 96 (e.g., beginning at time T1 as shown by curve 114), until the error voltage EV output by mixer 88 has been minimized (e.g., is equal to zero).

After a sufficient number of iterations through the loop, error voltage EV may be minimized (e.g., may become equal to zero). At this point (e.g., at a second time after the first time), laser 102 operates in the single-mode condition. Plot 108B illustrates the signal level of optical signal OPTSIG′ after laser 102 has entered the single-mode condition. As shown by plot 108B, phase adjustment feedback performed by optical phase shifter 100 based on error voltage EV may effectively reduce, eliminate, or remove all of the signal peaks/modes in optical signal OPTSIG′ except for a single signal peak/mode (e.g., at frequency M1).

Plot 110B illustrates electrical signal ESIG as produced by photodiode 84 based on the optical signal OPTSIG′ represented by plot 108B (e.g., at the second time, while laser 102 is in the single-mode condition). As shown by plot 110B, electrical signal ESIG only includes a signal peak at DC (e.g., the signal peaks at frequencies |M1−M2| and 2*|M1−M2| are no longer present because photodiode 84 performs a heterodyne operation on only a single signal peak at frequency M1 at the second time). Curve 122 of plot 118 illustrates the magnitude of error voltage EV at the second time. As shown by curve 122, while laser 102 is in the single-mode condition, error voltage may have a magnitude of zero (or some non-zero magnitude that is lower in magnitude than magnitude VA and that is given by a DC offset voltage generated by mixer 88 while operated in a stable condition). As shown by curve 116 of plot 112, this may cause comparator 92 to generate control signal CTRL with a similar magnitude of zero (or some non-zero magnitude less than magnitude VB), while laser 102 is in the single-mode condition. This effectively causes optical phase shifter 100 to stop adjusting the optical phase of the output of laser 102 (until error voltage EV increases). As shown by plot 106B of FIG. 3, while operating in the single-mode condition (e.g., at the second time), laser module 102 outputs optical local oscillator signal LO at only a single frequency M1 (e.g., because all other modes/signal peaks have been removed by multi-mode mitigation circuitry 104). This single-mode optical local oscillator signal LO may be used to perform any desired signal transmission in device 10.

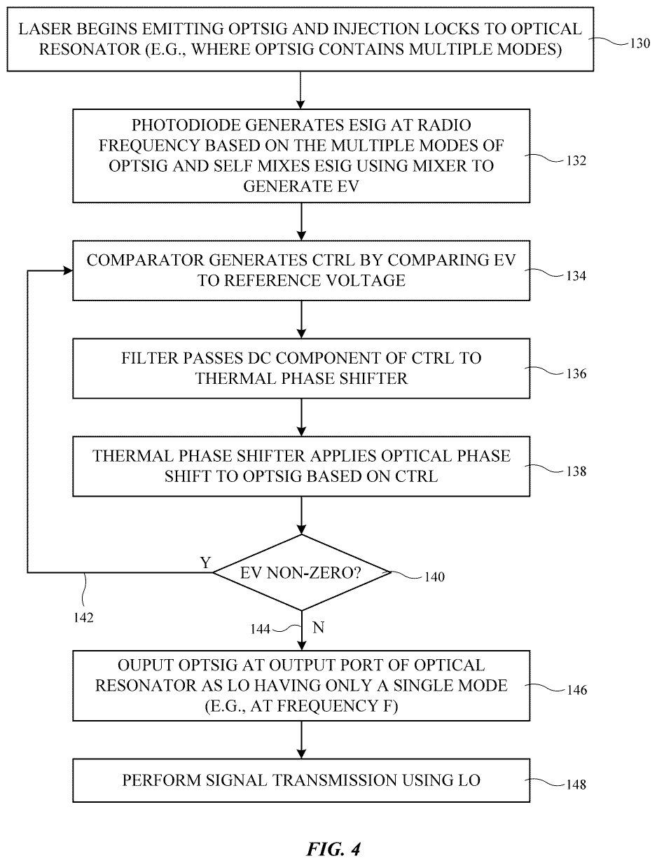

FIG. 4 is a flow chart of illustrative operations that may be performed by communications circuitry 20 (FIG. 1) to transmit signals using laser 102. At operation 130, laser 102 may be turned on, may begin emitting optical signal OPTSIG, and may become injection locked to optical resonator 40. Prior to performing multi-mode mitigation using multi-mode mitigation circuitry 104, laser 102 may be in a multi-mode condition and optical signal OPTSIG may include multiple signal peaks/modes. This also causes the corresponding optical signal OPTSIG′ on optical path 82 and the optical local oscillator signal LO output by optical module 70 to exhibit multiple signal peaks/modes (e.g., as shown by plots 108A and 106A). Operations 132-140 are associated with multi-mode mitigation performed for laser 102 by multi-mode mitigation circuitry 104.

At operation 132, photodiode 84 may begin generating electrical signal ESIG based on the optical signal OPTSIG′ output by optical resonator 40. Electrical signal ESIG may contain signal peaks at radio-frequencies (e.g., as shown by plot 110A) that are associated with beating between the multiple different signal peaks/modes in optical signal OPTSIG′. Mixer 88 may mix (multiply) electrical signal ESIG with itself (e.g., may self-mix electrical signal ESIG) to produce error voltage EV (e.g., as illustrated by the portion of curve 120 in plot 118 prior to time T1).

At operation 134, comparator 92 may generate control signal CTRL based on a comparison of the magnitude of error voltage EV to reference potential 94. While laser 102 is still in the multi-mode condition, error voltage EV may have magnitude VA, which causes comparator 92 to output control signal CTRL with magnitude VB (e.g., as illustrated by the portion of curve 114 in plot 112 prior to time T1).

At operation 136, filter 98 may filter control signal CTRL, passing only a DC component of control signal CTRL to thermal phase shifter 100. Alternatively, filter 98 of FIG. 3 and operation 136 of FIG. 4 may be omitted.

At operation 138, optical phase shifter 100 may apply and/or adjust an optical phase shift imparted to the optical signal OPTSIG on optical path 101 based on the magnitude of control signal CTRL (e.g., the DC voltage magnitude of the output of comparator 92). Different voltage magnitudes of control signal CTRL may, for example, cause optical phase shifter 100 to impart different respective optical phase shifts to the optical signal.

At operation 140, multi-mode mitigation circuitry 104 may determine whether error voltage EV is non-zero (e.g., when the output of the mixer includes no DC offset value). Alternatively, multi-mode mitigation circuitry 104 may determine whether error voltage EV exceeds a non-zero threshold such as reference potential 94 (e.g., the mixer may output a DC offset value due to one or more conditions such as biasing even when the electric signal includes no beating). If/when error voltage EV is still non-zero (e.g., when error voltage EV exceeds a threshold such as reference potential 94), processing may loop back to operation 132 via path 142 and multi-mode mitigation circuitry 104 may perform another iteration of adjustment to optical phase shifter 100.

If/when error voltage EV is equal to zero (or when error voltage EV is less than a threshold such as reference potential 94), processing may proceed to operation 144. When this occurs, optical signal OPTSIG′ has only a single signal peak/mode (as shown by plot 108B) and electrical signal ESIG has only a DC component (as shown by plot 110B). At this point, laser 102 is in a single-mode condition. At operation 146, optical module 70 may begin to output an optical local oscillator signal LO that includes only a single signal peak/mode (as shown by plot 106B).

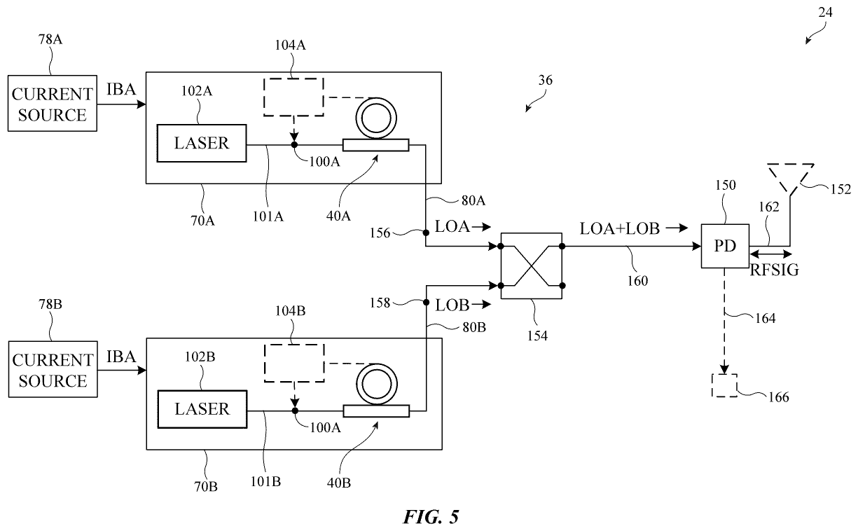

At operation 148, communications circuitry 20 may perform any desired signal transmission using or based on the optical local oscillator signal LO containing only a single signal peak/mode. In one illustrative implementation that is described herein as a non-limiting example, wireless circuitry 24 may use optical local oscillator signals at two different frequencies from two different laser modules to convey wireless signals 32 and 34 of FIG. 1. FIG. 5 is a circuit diagram showing one example of how wireless circuitry 24 may include circuitry that uses optical local oscillator signals LO at two different frequencies from two different laser modules to convey wireless signals 32 and 34 of FIG. 1.

As shown in FIG. 5, wireless circuitry 24 may include a first optical module 70A and a second optical module 70B. Optical module 70A may include a corresponding laser 102A that is coupled to optical resonator 40A over optical path 101A. Optical module 70A may also include multi-mode mitigation circuitry 104A coupled in a loop path between optical resonator 40A and an optical phase shifter 100A on optical path 101A (e.g., as shown by multi-mode mitigation circuitry 104 of FIG. 3). Alternatively, multi-mode mitigation circuitry 104A may be implemented external to optical module 70A.

Optical module 70B may include a corresponding laser 102B that is coupled to optical resonator 40B over optical path 101B. Optical module 70B may also include multi-mode mitigation circuitry 104B coupled in a loop path between optical resonator 40B and an optical phase shifter 100B on optical path 101B (e.g., as shown by multi-mode mitigation circuitry 104 of FIG. 3). Alternatively, multi-mode mitigation circuitry 104B may be implemented external to optical module 70B.

During signal transmission, a current source 78A may supply a bias current IBA that controls laser 102A to emit a corresponding optical signal at a first frequency. When laser 102A is first turned on, the laser may operate in a multi-mode condition. Multi-mode mitigation circuitry 104A may then begin to adjust optical phase shifter 100A (e.g., using the operations of FIG. 4) until laser 102A enters a single-mode condition and outputs a corresponding optical local oscillator signal LOA on optical path 80A. Optical local oscillator signal LOA may contain a single signal peak/mode at a first optical frequency FA.

At the same time, a current source 78B may supply a bias current IBB that controls laser 102B to emit a corresponding optical signal at a second frequency. When laser 102B is first turned on, the laser may operate in a multi-mode condition. Multi-mode mitigation circuitry 104B may then begin to adjust optical phase shifter 100B (e.g., using the operations of FIG. 4) until laser 102B enters a single-mode condition and outputs a corresponding optical local oscillator signal LOB on optical path 80B. Optical local oscillator signal LOB may contain a single signal peak/mode at a first optical frequency FB.

As shown in FIG. 5, wireless circuitry 24 may also include an optical coupler 154, an optical path 160, an electro-optical photomixer or photo-mixing device such as photodiode 150, and an electrical path 162. If desired, wireless circuitry 24 may include an antenna resonating element such as antenna element 152 (e.g., one or more antenna arms, slot antenna elements, patch antenna elements, dipole antenna arms, monopole antenna arms, inverted-F antenna arms, bowtie antenna arms, etc.). Antenna element 152 may be coupled directly to electrical path 162 or may be directly connected to an electrical output terminal of photodiode 150. Antenna element 152 and optionally its corresponding photodiode 150 may, for example, form an antenna 30 in device 10 (FIG. 1).

Optical path 80A may optically couple optical module 70A to a first input terminal (port) of optical coupler 154 (e.g., an optical combiner). Optical path 80B may optically couple optical module 70B to a second input terminal (port) of optical coupler 154. Optical coupler 154 may have an output terminal (port) that is optically coupled to a photosensitive area photodiode 150 by optical path 160. If desired, receiver circuitry such as receiver 166 (e.g., containing a downconversion circuitry, demodulator circuitry, analog-to-digital converter circuitry, optical receiver circuitry, intermediate frequency receiver circuitry, etc.) may be communicatively coupled to photodiode 150 over receive path 164. Receive path 164 may include one or more optical paths that convey optical signals or one or more electrical paths that convey electrical signals from photodiode 150 to receiver 166 (e.g., radio or intermediate frequency transmission line paths).

If desired, wireless circuitry 24 may include an electro-optical modulator (e.g., a Mach-Zender Modulator (MZM) and/or an optical phase shifter disposed on optical path 80A (e.g., at node 156). Additionally, or alternatively, wireless circuitry 24 may include an electro-optical modulator and/or an optical phase shifter disposed on optical path 80B (e.g., at node 158). During operation, optical module 70A may output optical local oscillator signal LOA on optical path 80A (e.g., while laser 102A is operating as a single-mode laser under the control of multi-mode mitigation circuitry 104A). At the same time, optical module 70B may output optical local oscillator signal LOB on optical path 80B (e.g., while laser 102B is operating as a single-mode laser under the control of multi-mode mitigation circuitry 104B). Optical coupler 154 may combine optical local oscillator signals LOA and LOB onto optical path 160. Optical path 160 may illuminate the photosensitive area of photodiode 150 using the combination of optical local oscillator signals LOA and LOB.

Photodiode 150 may generate a radio-frequency signal RFSIG at its electrical output terminal based on optical local oscillator signals LOA and LOB. Photodiode 150 may produce radio-frequency signal RFSIG as an electromagnetic beating between optical local oscillator signals LOA and LOB. Radio-frequency signal RFSIG may be at a frequency given by the difference in frequency between frequencies LOA and LOB (e.g., radio-frequency signal RFSIG may be at a frequency equal to |FA−FB|). The frequencies of optical local oscillator signals LOA and LOB may be selected to produce radio-frequency signal RFSIG at a sub-THz frequency, as one example (e.g., for supporting extremely high data rates).

If desired, electrical path 162 may carry radio-frequency signal RFSIG between photodiode 150 and another node in device 10 or external to device 10 (e.g., via a radio-frequency connector). Alternatively, if desired, antenna element 152 may wirelessly convey radio-frequency signal RFSIG (e.g., as wireless signals 32 and 34 of FIG. 1). If desired, photodiode 150 may include a programmable photodiode such as a uni-travelling-carrier photodiode (UTC PDs) that receives different bias voltages to switch the photodiode between a signal transmit and receive modes. In the transmit mode (e.g., under a first bias voltage setting), photodiode 150 transmits radio-frequency signal RFSIG on electrical path 162 and/or via antenna element 152 (e.g., antenna element 152 may radiate radio-frequency RFSIG). In the receive mode (e.g., under a second bias voltage setting), photodiode 150 receive radio-frequency signal RFSIG from electrical path 162 and/or antenna element 152. Photodiode 150 may pass the received signal to receiver 166 over signal path 164 as an electrical signal or as an optical signal (e.g., photodiode 150 may exhibit one or more modes in which the photodiode converts a received electrical signal into optical energy on signal path 164).

If desired, an electro-optical modulator at node 156 or node 158 may modulate wireless data (e.g., a stream of data packets, symbols, datagrams, frames, etc.) onto one of the optical local oscillator signals (e.g., using an electrical signal received from a digital-to-analog converter or a transmit chain that is supplied to one or more electrodes of the electro-optical modulator, which modulates the optical local oscillator signal to include wireless data carried by the electrical signal). Photodiode 150 may preserve the wireless data in radio-frequency signal RFSIG (e.g., radio-frequency RFSIG may carry the wireless data for transmission to an external device). If desired, an optical phase shifter at node 156 or node 158 may apply an optical phase shift to the corresponding optical local oscillator. Photodiode 150 may preserve the phase shift as a corresponding electrical phase shift for radio-frequency signal RFSIG. This phase shift may, for example, be used to perform signal beam steering in implementations where antenna element 152 is included within a phased antenna array of device 10. The example of FIG. 5 is illustrative and non-limiting and, in general, laser modules 70 may be used to perform any desired signal transmission and/or reception for or within device 10.

In this way, signal generation circuitry 36 may generate a stable, single-mode, optical local oscillator signal LO for use in performing communications, without requiring multiple bulky optical resonators for each laser (e.g., the components of multi-mode mitigation circuitry 104 may be smaller than a single optical resonator 40). In addition, multi-mode mitigation circuitry 104 may reduce or eliminate the need for additional thermal control of optical resonator 40.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is

1. Communication circuitry comprising:
a laser;
an optical resonator having a first port and a second port;
a first optical path that couples the laser to the first port of the optical resonator;
an optical phase shifter on the first optical path;
a photodiode;
a second optical path that couples the second port of the optical resonator to the photodiode;
a comparator;
a mixer coupled between the photodiode and an input of the comparator; and
a control path that couples an output of the comparator to the optical phase shifter.

2. The communication circuitry of claim 1, further comprising:
an electrical path that couples the photodiode to a first input and a second input of the mixer.

3. The communication circuitry of claim 2, wherein the laser is configured to emit an optical signal, the photodiode is configured to generate an electrical signal based on the optical signal, and the mixer is configured to generate an error voltage by mixing the electrical signal with itself.

4. The communication circuitry of claim 3, wherein:
the comparator has an additional input that receives a reference potential, and
the comparator is configured to generate a control signal on the control path based on the error voltage and the reference potential.

5. The communication circuitry of claim 4, wherein:
the optical phase shifter is configured to apply an optical phase shift to the optical signal; and
the control signal is configured to adjust the optical phase shift.

6. The communication circuitry of claim 5, wherein the control signal is configured to adjust the optical phase shift at least until the error voltage is less than the reference potential.

7. The communication circuitry of claim 1, further comprising:
an optical output path coupled to a third port of the optical resonator, wherein the optical resonator is configured to output an optical local oscillator (LO) signal on the optical output path and wherein the communication circuitry is configured to convey wireless data based on the optical LO signal.

8. The communication circuitry of claim 7, further comprising:
a photodiode optically coupled to the optical output path; and
an antenna arm coupled to the photodiode, wherein the optical LO signal is at a first frequency, the photodiode is configured to generate a radio-frequency signal on the antenna arm based on the optical LO signal and an additional optical LO signal, and the additional optical LO signal is at a second frequency different from the first frequency.

9. The communication circuitry of claim 1, further comprising:
a low pass filter disposed on the control path.

10. The communication circuitry of claim 1, wherein the optical resonator comprises an optical ring.

11. A method of generating an optical signal usable for performing communications, the method comprising:
generating, using a laser coupled to a first port of an optical resonator, the optical signal as a multi-mode signal while the laser is injection-locked to the optical resonator; and
converting, using circuitry coupled in a loop between a second port of the optical resonator and an optical phase shifter, the optical signal into a single-mode signal while the laser is injection-locked to the optical resonator, wherein the optical phase shifter is coupled between the laser and the first port of the optical resonator.

12. The method of claim 11, wherein the multi-mode signal comprises a plurality of signal peaks at respective frequencies and wherein the single-mode signal comprises a single signal peak from the plurality of signal peaks.

13. The method of claim 11, wherein converting the optical signal comprises:
generating, using a photodiode, an electrical signal based on the multi-mode signal.

14. The method of claim 13, wherein converting the optical signal further comprises:
mixing, using a mixer, the electrical signal with itself to produce an error voltage.

15. The method of claim 14, wherein converting the optical signal further comprises:
generating, using a comparator, a control signal by comparing the error voltage to a reference potential; and
adjusting, using the optical phase shifter, an optical phase shift imparted to the optical signal based on the control signal.

16. Communication circuitry comprising:
a first optical resonator;
a first laser coupled to a first port of the first optical resonator and configured to generate a first optical signal at a first frequency while injection-locked to the first optical resonator;
an optical phase shifter coupled between the first laser and the first port; and
multi-mode mitigation circuitry coupled in a loop between a second port of the optical resonator and the optical phase shifter, wherein the multi-mode mitigation circuitry is configured to adjust the optical phase shifter while the first laser emits the first optical signal in a multi-mode condition until the first laser emits the first optical signal in a single-mode condition.

17. The communication circuitry of claim 16, further comprising:
a second laser configured to generate a second optical signal at a second frequency that is different from the first frequency;
an optical combiner having a first input communicatively coupled to a third port of the first optical resonator over a first optical path and having a second input communicatively coupled to the second laser over a second optical path; and
a photodiode communicatively coupled to an output of optical combiner over a third optical path, wherein the photodiode is configured to generate an electrical signal at a third frequency equal to a difference between the first frequency and the second frequency.

18. The communication circuitry of claim 17, further comprising:
a second optical resonator, wherein the second laser is coupled to a third port of the second optical resonator and wherein the second optical path is coupled to a fourth port of the second optical resonator.

19. The communication circuitry of claim 16, wherein the multi-mode mitigation circuitry comprises:
a photodiode optically coupled to the second port of the optical resonator;
a mixer having first and second inputs coupled to an electrical terminal of the photodiode in parallel; and
a comparator, wherein the comparator has a first input coupled to an output of the mixer, a second input that receives a reference potential, and an output that is operably coupled to the optical phase shifter.

20. The communication circuitry of claim 16, wherein:
the optical resonator comprises an optical ring,
the first optical signal includes a plurality of signal peaks as a function of frequency while the first laser is in the multi-mode condition, and
the first optical signal has a single signal peak while the first laser is in the single-mode condition.
